(19) United States
(12) Patent Application Publication
(10) Pub. No.: US 2011/0090109 A1
(43) Pub. Date: Apr. 21, 2011

(54) Charge pump

(76) Inventors: Armin Himmelstoss, Weissach Im Tal (DE); Reiner Schnitzer, Reutlingen (DE); Frank Huembert, Stuttgart (DE)

(21) Appl. No.: 12/308,288

(22) PCT Filed: Oct. 2, 2007
(86) PCT No.: PCT/EP2007/060464

§ 371 Date: Jan. 4, 2011

(30) Foreign Application Priority Data
Nov. 29, 2006 (DE) 10 2006 056 329.8

(51) Int. Cl. G01S 13/00; H02M 3/07

(52) U.S. Cl. 342/83; 363/61

(57) ABSTRACT

A charge pump includes: a control input for applying a control pulse, a pulsed current source for generating a current pulse in accordance with the control pulse, a direct current source for generating a direct current, and a current output that is connected to the pulsed current source and to the direct current source.

### FIELD OF THE INVENTION

The present invention relates to a charge pump and a phase-coupled control loop that contains the charge pump. Furthermore, the present invention relates to a method for operating a charge pump in a phase-coupled control loop.

### BACKGROUND INFORMATION

Below, a problem that provides the basis of example embodiments of the present invention is explained with the aid of a phase-coupled control loop (phase-locked loop, PLL), in particular, a phase-coupled control loop that is used in an FMCW radar.

An FMCW radar requires a high-frequency signal whose frequency is varied over time according to a fixed pattern, typically at a frequency that is changed temporarily in the form of a triangle. The pattern is transferred onto the high-frequency signal by a phase-coupled control loop that is adjusted to a reference signal that is accordingly modified over time, or adjusted to a constant reference signal using multiples of the reference frequency that are modified over time.

A schematic structure of such a phase-coupled control loop 1 is shown exemplarily in FIG. 1. It includes a reference signal source 2 that provides reference signal 3, a voltage-controlled oscillator 4 for generating high-frequency signal 5, and an output 6 for outputting high-frequency signal 5. Both reference signal 3 and high-frequency signal 5, or a signal 9 divided by a frequency divider 8 are supplied to a phase detector 7 to determine a difference between the respective phases. Phase detector 7 outputs a pulsed control signal 10 to a charge pump 11 as a function of the phase difference, as indicated in FIG. 2, for example. In response to control signal 10, charge pump 11 generates current pulses 12, which charge a downstream capacitor 13. The voltage level of capacitor 13 is coupled with the control input of voltage-controlled oscillator 4 and thus influences the frequency of high-frequency signal 5.

The spectrum of high-frequency signal 4 from phase-coupled control loop 1 is shown schematically in FIG. 3. In addition to main signal 20 of high-frequency signal 4, which has desired frequency F0, additional signal contributions, which are described below as secondary lines 21, 22, are produced at frequencies F0-d and F0+d. These secondary lines 21, 22 form as a result of appearing control pulses 10 of phase detector 7 or of charge pump 11, which appear in a manner synchronized with reference signal 3 in order to keep high-frequency signal 4 synchronous with reference signal 3. On average, frequency distance d corresponds to the reference frequency.

The signal contributions in secondary lines 21, 22 interfere considerably with the signal analysis in an FMCW radar. A simple suppression of secondary lines 21, 22 through downstream variable low-pass filters is not expedient.

### SUMMARY

The charge pump according to example embodiments of the present invention advantageously reduces the signal contribution from secondary lines when used in a phase-coupled control loop of an FMCW radar.

According to example embodiments of the present invention, the charge pump contains:
a control input for applying a control pulse,
a pulsed current source for generating a current pulse in accordance with the control pulse,
a direct current source for generating a direct current, and
a current output that is connected to the pulsed current source and to the direct current source.

One measure of example embodiments of the present invention is that the charge pump outputs a direct current. In a phase-coupled control loop, this direct current causes the frequency of the output signal of a voltage-controlled oscillator to continuously increase or decrease, when the direct current has a different polarity. Thus, the phase difference between the output signal and the reference signal is smaller. Assuming that the polarity of the direct current is selected such that the frequency of the output signal increases or decreases synchronously with the reference signal and/or the divider ratio of the divider. The smaller phase difference, which constitutes the control variable of the phase-coupled control loop, results in weaker control signals or no control signals, that is, current pulses through the charge pump. Consequently, the intensity of the secondary lines advantageously decreases.

In example embodiments, the direct current source is adjustable and has a control input for adjusting the direct current. In particular, the direct current is able to be set to negative current values and positive current values. Preferably, it is possible to set current values having different absolute values as well, in order to implement different frequency change rates over time for output signals of a voltage-controlled oscillator. In the ideal case, the direct current is set such that it directly causes the frequency of the voltage-controlled oscillator to change, this change being predetermined by the change of the reference signal and/or of the divider ratio. In voltage-controlled oscillators having an ideal linear relationship between control voltage and output signal frequency, this may be achieved by one single signal current value per change rate of the frequency of the reference signal and/or divider ratio of the frequency divider.

A further example embodiment provides that the charge pump has a device for detecting pulse width that is coupled with the control input to detect the pulse width of the control pulse, and a control device that is coupled with the control input of the direct current source in order to adjust the direct current in response to the pulse width of the control pulse. This measure is based on the fact that the pulse width is an index of the control activity of a phase-coupled control loop. The greater the average pulse width, the more the phase-coupled control loop is adjusting the frequency of the output signal of the voltage-controlled oscillator to the reference frequency signal. In this further refinement, the control deviation, that is, the pulse width, is reduced by the fact that the direct current is increased when the pulse width increases (in absolute value). This is advantageous in particular if the frequency of the output signal of the voltage-controlled oscillator does not have a linear relationship to the input voltage at its control input.

An example embodiment provides a second control input for applying second control pulses instead of first control pulses, in response to which the pulsed current source outputs second current pulses. The device for detecting pulse width may be set up to detect the pulse width of the second control pulses. The control device reduces the direct current if second control pulses are detected and increases the direct current if first control pulses are detected.

The device for detecting pulse width may be designed as an integrator or as a filter. The device for detecting pulse width may also have a digital scanning device for the pulse width.

In example embodiments, the pulsed current source is set up to output, in response to the control pulse, a current pulse having the same pulse width as the pulse width of the control pulse.

In example embodiments, the pulsed current source is set up such that it outputs in response to the control pulse a first and a second current pulse having one pulse width respectively, the pulsed current source being coupled with a reference signal source in order to output the first current pulse along with a rising edge of a reference frequency signal from the reference signal source, and the second current pulse along with a falling edge of the reference frequency signal. The current pulses are generated at a rate double that of the specific embodiments described previously. This is advantageous in two different respects. First, the frequency spacing between the secondary lines and the actually desired signal of the voltage-controlled oscillator doubles. Second, the control signal is distributed among two current pulses, which means the intensity of the signals in the secondary lines is reduced.

A phase-coupled control loop may contain:

a voltage-controlled oscillator having a control input for generating an output signal having a frequency,
a reference frequency signal source for generating a reference signal having a reference frequency,
a phase detector for outputting a control pulse in response to a phase difference between the output signal and the reference signal,
the charge pump according to example embodiments of the present invention whose control input is coupled with the phase detector for transmitting the control pulses, and
a filter that is disposed between the current output of the charge pump and the control input of the voltage-controlled oscillator.

The reference frequency signal source may be adjustable in order to output an adjustable reference signal and to adjust the frequency of the output signal.

The phase-coupled control loop may have an adjustable frequency divider, which is interposed between the voltage-controlled oscillator and the phase detector, in order to adjust the frequency of the output signal.

The phase-coupled control loop may be used in an FMCW radar for the automotive sector.

A method for regulating a phase-coupled control loop for an FMCW radar has the following method steps:

outputting an actual signal via a voltage-controlled oscillator,
providing a reference signal,
varying the reference signal so that it has a monotonously growing frequency, at least during one time span, and/or dividing the frequency of the actual signal via a monotonously growing divider;
determining a phase difference between the reference signal and the actual signal;
generating a current pulse having a pulse width in response to the determined phase difference;
generating a direct current at least during the time span; superimposing the direct current with the current pulse to form one current signal; and
supplying the current signal to a control input of a controllable oscillator that generates the actual signal.

### BRIEF DESCRIPTION OF THE DRAWINGS

FIG. 1 shows a block diagram of a conventional phase-coupled loop;

FIG. 2 shows signals of the phase-coupled control loop shown in FIG. 1;

FIG. 3 shows a spectrum of the output signal from FIG. 1;

FIG. 4 shows a time-variable output signal from FIG. 3;

FIG. 5 shows an example embodiment of a charge pump used in a phase-coupled control loop;

FIG. 6 shows signals of the phase-coupled control loop shown in FIG. 5;

FIG. 7 shows an example embodiment of the charge pump;

FIG. 8 shows signals for FIG. 1;

FIG. 9 shows an example embodiment of the charge pump;

FIG. 10 shows an example embodiment of the charge pump; and

FIG. 11 shows signals for FIG. 10.

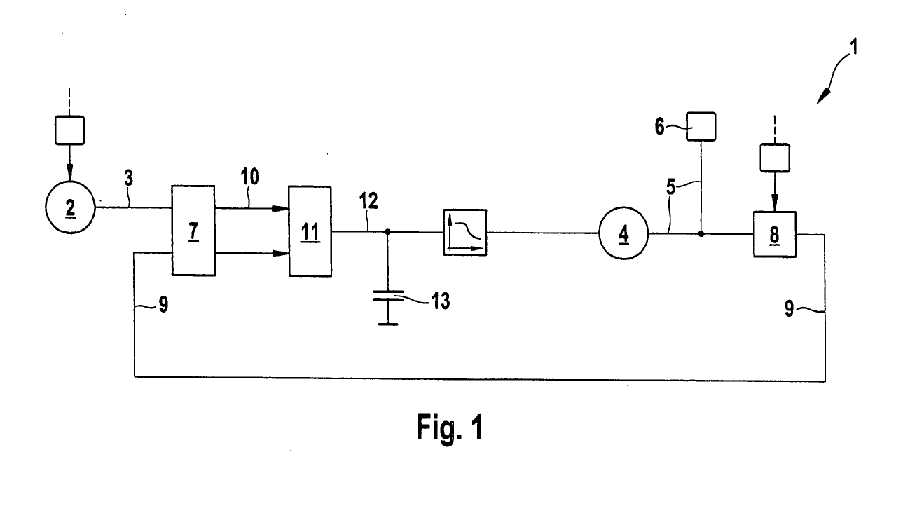

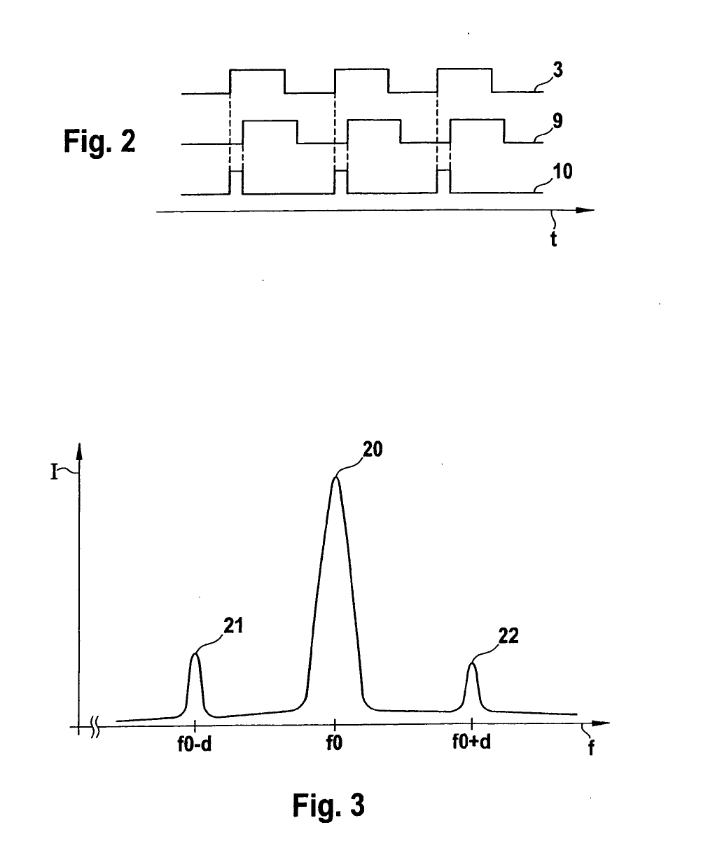

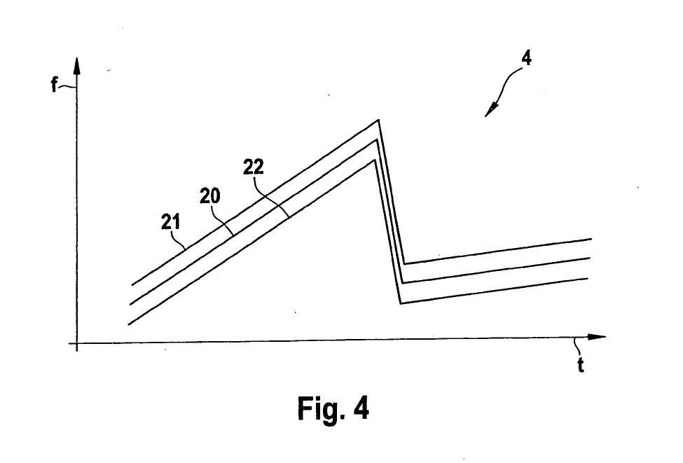

### DETAILED DESCRIPTION

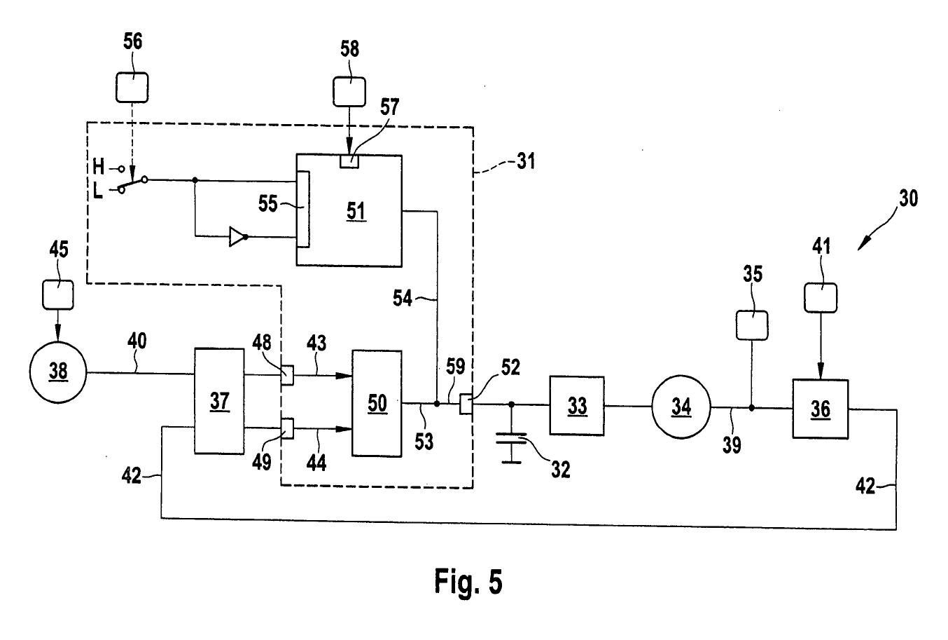

FIG. 5 shows a control loop 30 in which an example embodiment of charge pump 31 is integrated. In addition to charge pump 31, phase-coupled control loop 30 has a capacitor 32, a filter 33, a voltage-controlled oscillator 34, an output 35, a frequency divider 36, a phase detector 37, which is typically designed as a phase frequency detector, and a reference signal source 38. Phase-coupled control loop 30 ensures that a ratio between the frequency of an output signal 39 of voltage-controlled oscillator 34 and the frequency of a reference signal 40 of reference signal source 38 remains constant in the context of the control rate of phase-coupled control loop 30. The ratio corresponds to the division ratio that is predefined by frequency divider 36.

The frequency of the output signal is preferably varied by changing the division ratio of frequency divider 36. Similarly, the frequency may also be varied by modifying the reference frequency.

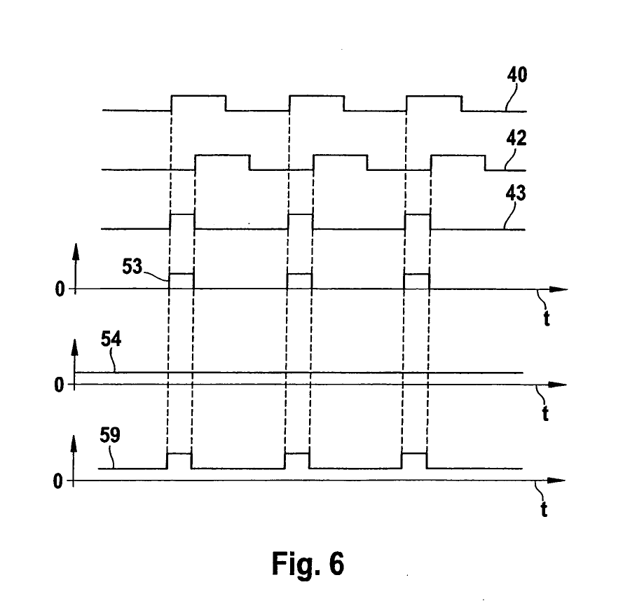

The division ratio of frequency divider 36 may be adjusted by a control device 41, in order to set, and possibly to modify, the ratio between the frequency of output signal 39 and the frequency of reference signal 40. Divided signal 42, which is output by frequency divider 36, is supplied to phase detector 37 along with reference signal 40. Phase detector 37 determines the phase difference between these two signals 40, 42. In the example shown in FIG. 6, phase detector 37 outputs a first phase difference signal 43 if reference signal 40 runs ahead of divided signal 42. The width of the pulses of phase difference signal 43 corresponds to the phase difference between reference signal 40 and divided signal 42. If the reference signal lags behind divided signal 42, phase detector 37 outputs a second phase difference signal 44 instead of first reference signal 43.

Reference signal 40, which is output by reference signal source 38, may be varied in its frequency by a control device 45. When phase-coupled control loop 30 is used in an FMCW radar (not shown), the frequency of reference signal 40 may be modified section-by-section at a constant modification rate. Preferably, it is possible to set different modification rates both in terms of the absolute value and in terms of sign, that is, having decreasing or increasing frequency.

First phase difference signal 43 and second phase difference signal 44 respectively serve as control signals for charge pump 31, which are able to be supplied via control inputs 48 and 49.

Charge pump 31 has a pulsed current source 50 and a direct current source 51 that are connected in parallel to a shared output 52 of charge pump 31.

Control signals 43, 44 are supplied to pulsed current source 50. Triggered by first control signal 43, pulsed current source 50 outputs a first current pulse 53, the pulse width of which is typically identical to the pulse width of control signal 43. In the event of a second control signal 44, pulsed current source 50 outputs a second current pulse. The first and second current pulse have opposite polarities, in order to either increase or decrease the actual frequency of the voltage-controlled oscillator. Current pulses 53 are shown as examples in FIG. 6, plotted over time t together with an associated reference signal 40, a divided signal 42, and a phase difference signal 43.

Direct current source 51 outputs a direct current 54. Direct current source 51 has a control input 55, via which the polarity of the direct current may be adjusted. A corresponding control device 56 controls the polarity of direct current 54 via control input 55. Advantageously, direct current source 51 has an additional control input 57, via which a control device 58 is able to adjust the current value, possibly also the polarity of direct current 54. An example for a direct current 54 is shown in FIG. 6 plotted over time t.

Direct current 54 and current pulses 53 add up to one charging current 59 in the output of charge pump 31. Charging current 59 is illustrated graphically in FIG. 6. Charging current 59 charges capacitor 32 having downstream filter 33 or an integrator designed in another manner. The voltage signal of capacitor 32 triggers voltage-controlled oscillator 34.

The meaning of direct current source 51 of charge pump 31 is explained below.

First, let it be assumed that direct current 54 is set to zero ampere. Furthermore, reference signal 40 predetermines a monotonously increasing reference frequency. Phase-coupled control loop 30 continually adjusts the frequency of output signal 39 to the increasing reference frequency or on the basis of the increasing divider ratio. To this end, phase detector 37 determines the present phase difference between reference signal 40 and signal 42 derived from output signal 39 or output signal 39. The continuously growing reference frequency or a continuously growing divider ratio results in a continuous phase difference. The phase difference is determined in a system-controlled manner by phase detector 37 in step with reference signal 40. In the example illustrated in FIG. 6, the phase difference is determined when the edge of reference signal 40 rises. Control pulses 43 having a width corresponding to the phase difference are consequently produced, control pulses 43 occurring in step with reference signal 40. Control pulses 43 are converted by charge pump 31 into current pulses 53 and by capacitor 32 into voltage pulses. Voltage-controlled oscillator 34 reacts by raising the frequency of its output signal 39 in a clocked manner.

The clocking leads to a modulation of output signal 39. In a spectral analysis of output signal 39, the modulation appears as secondary lines at frequencies that differ from the average frequency of output signal 39 by the reference frequency, that is, the clock pulse. The amplitude of the secondary lines, that is, the power of output signal 39, which is emitted with the frequency of the secondary lines, rises as the strength of current pulses 53 or voltage pulses at voltage-controlled oscillator 34 increases.

Direct current 54 uniformly charges capacitor 32 and thus causes the frequency of output signal 39 to grow uniformly. In this connection, no secondary lines result. The essential measure of charge pump 31 thus lies in providing a direct current 54 that triggers voltage-controlled oscillator 34 such that the desired time-dependency of the frequency of output signal 39 is already approximately achieved. The remaining phase differences are corrected by phase-coupled control loop 30. Current pulses 53 that occur in this connection to offset the now smaller phase differences are weaker, that is, they have a shorter pulse width, and consequently lead to small contributions in the secondary lines.

In the most simple manner, a negative direct current 54 is provided if the frequency of the output signal is to be decreased, and a positive direct current 54 is provided if the frequency of output signal 39 is to be increased. Control device 56 switches between negative and positive direct current 54. The switchover should take place if the change rate of the output frequency is modified, that is, if the change rate of the reference frequency or of the divider ratio is modified.

The current value of direct current 54 is advantageously adjusted to utilized voltage-controlled oscillator 34 and to capacitor 32. The average rate at which the frequency of output signal 39 is changed by direct current 54 should correspond approximately to the change rate of output signal 39 predetermined by reference signal 40 or by the divider ratio.

In practice, in most voltage-controlled oscillators 34, the frequency of output signal 39 does not have a linear relationship to the input voltage. Accordingly, suitable frequency ranges are to be selected, or a direct current 54 is to be selected from which the smallest average deviation from the predefined frequency characteristic is to be expected.

In one refinement, direct current source 51 is provided with a plurality of current sources or with one adjustable current source. This is used in order to emulate different frequency change rates.

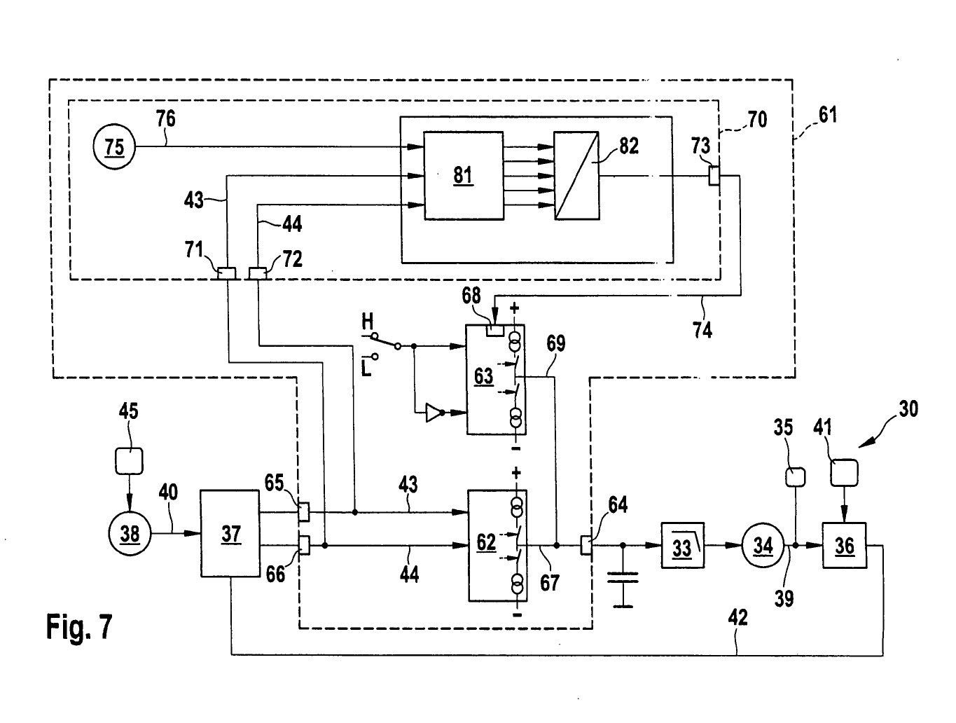

A further refinement of the charge pump is shown in FIG. 7. One or two signal input/s 65, 66 is/are provided for charge pump 61, via which signal inputs charge pump 61 may be connected to a phase detector 37 in order to receive phase difference signals 63, 64. The inputs of pulsed current source 62 connect it to signal inputs 65, 66. Charge pump 62 outputs current pulses 46 in accordance with phase difference signals 43, 44, current pulses 46 having a width that in essence corresponds to the width of the pulses of phase difference signals 43, 44.

Direct current source 63 has a control input 68 via which the absolute value and if applicable the sign of direct current 69 output by direct current source 63 is able to be set. Additionally, charge pump 61 has a direct-current control device 70 whose signal inputs 71, 72 are connected to signal inputs 65, 66 of charge pump 61. Signal output 73 of direct-current control device 70 is connected to control input 68 of direct current source 60.

The principle of direct-current control device 70 is to detect the pulse width of phase difference signals 43, 44 and to output a control signal 74 that brings about an increasing direct current 69 in the event of an increasing pulse width of phase difference signals 43, 44. In the simplest case, control signal 74 is a voltage signal or a digital signal whose absolute value is proportional to the width of phase difference signals 43, 44.

The direct current source may provide a continuously variable direct current or a direct current that may be varied in steps.

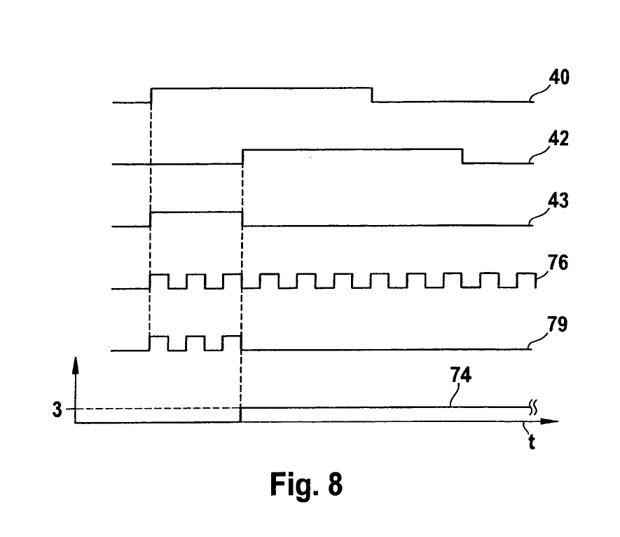

Direct-current control device 70 shown in FIG. 7 is essentially a pulse-width detection device and to this end digitally scans the pulse widths of phase difference signals 43, 44, which are supplied via signal inputs 71, 72. FIG. 8 shows, by way of example, a phase difference signal 43 plotted over time t that results for reference frequency signal 40 and divided signal 42.

Direct-current control device 70 has a clock generator 75 that outputs a high-frequency clock signal 76 that is supplied to a counter module 81. Additionally, phase difference signal 43, 44 is supplied to counter module 81. Phase difference signal 43, 44 may act as a trigger for counter module 81. Counter 81 counts the pulses of signal 79 and triggers a digital/analog converter 82, which subsequently generates a control signal 74 that corresponds to the count value. In the example shown as an illustration in FIG. 8, control signal 74 receives a voltage level that corresponds to three count values.

Direct current control 70 modifies direct current 69 only if the change rate of the reference frequency of reference signal 39 or of the divider ratio of the frequency divider changes, or if there is a significant non-linear relationship between the frequency of output signal 41 and the voltage control signal at the control input of voltage-controlled oscillator 34. Consequently, due to its infrequent or low control activity, direct-current control device 70 does not result in any secondary lines or results only in weak secondary lines in output signal 41 of phase-coupled control loop 30.

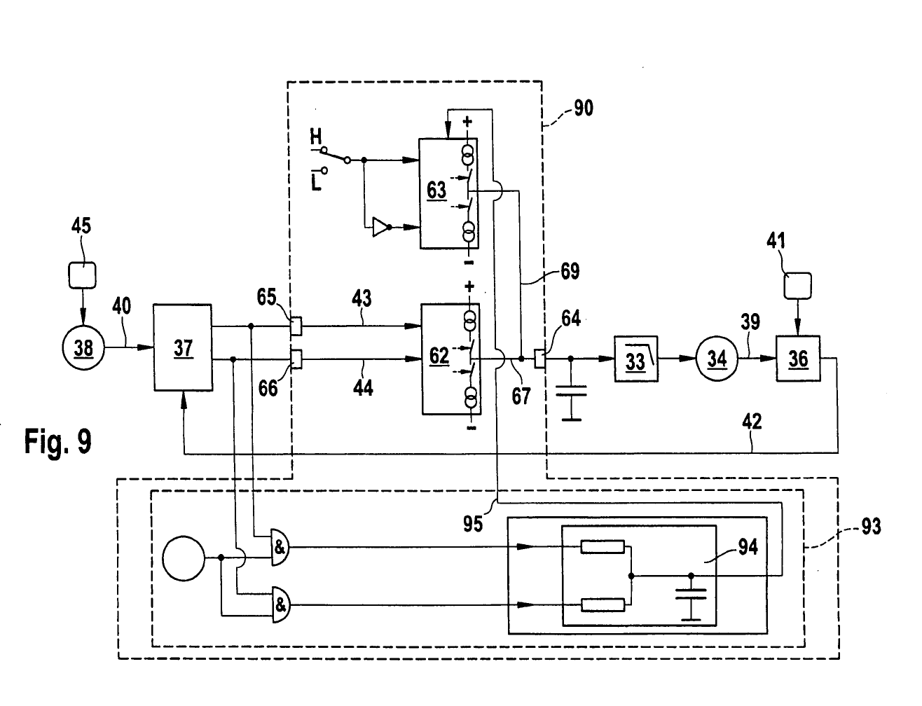

FIG. 9 illustrates a further development of charge pump 90. As in the previously described specific embodiment, charge pump 90 is made up of a pulsed current source 62, a direct current source 63, and a direct current control 93. Direct current control 93 is formed by an analog integrator 94. Phase difference signals 43, 44 are applied to analog integrator 94. Output signal 95 of integrator 94 serves as a control signal for direct current source 63.

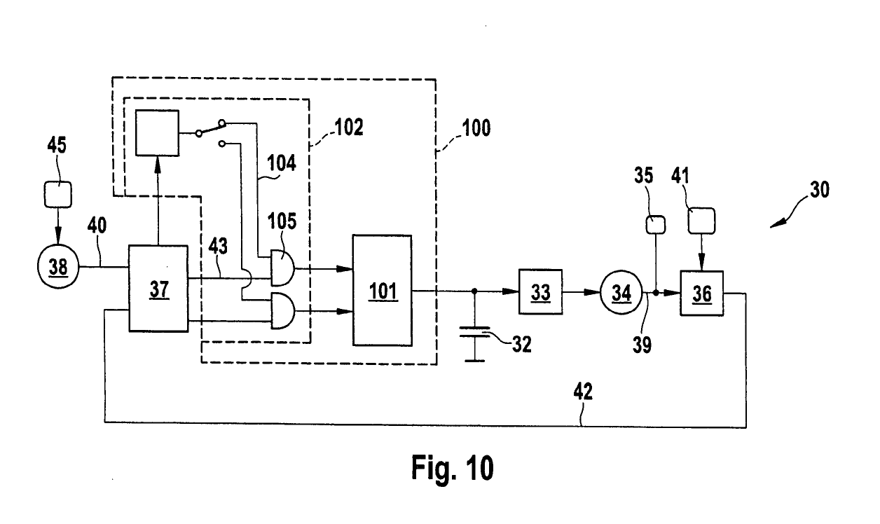

FIG. 10 illustrates an example embodiment of charge pump 100. It is also for use in a phase-coupled control loop 30. Charge pump 100 has a pulsed current source 101 and a pulse doubling device 102. Pulse doubling device 102 is connected between the control inputs of pulsed current source 101 and signal inputs of charge pump 100, via which phase difference signals are injected.

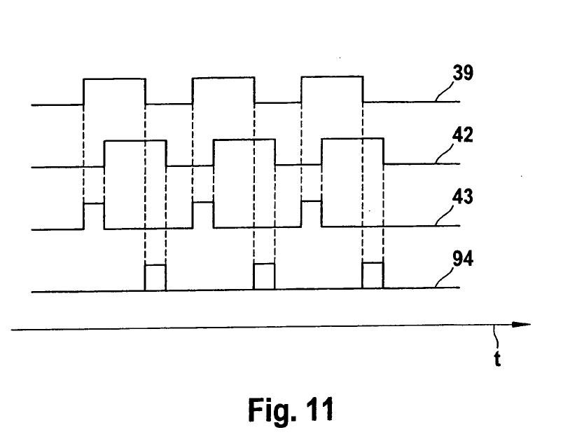

A phase detector 37 determines the phase difference between two input signals 40, 42 either at a rising edge of reference signal 40 or at its falling edge. FIG. 11 illustrates this by way of example for the rising edge. Phase detector 37 outputs a voltage pulse having phase difference signal 43 between a rising edge of reference signal 40 and the rising edge of comparison signal 42. The repetition rate of these voltage pulses 43 thus corresponds to the clock-pulse rate of reference signal 40. As explained previously, this clock-pulse rate causes secondary lines in output signal 39 of a phase-coupled control loop 39 having a frequency spacing identical to this clock-pulse rate with regard to the frequency of the desired main signal.

Frequency doubling device 102 is set up such that it generates for the pulses of phase difference signal 43 additional pulses in a doubling signal 104. These correspond to phase difference signals determined between the falling edge of reference signal 40 and the falling edge of comparison signal 42. Phase difference signal 43 and doubling signal 104 are added to form one common signal in a linkage unit 105. The pulses now ensue at a clocking double that of the clock pulse of reference signal 40. Correspondingly, the frequency of the secondary lines shifts away from the main frequency. This larger frequency spacing enables a simpler separation. In addition, the signal intensity in the secondary lines falls when the clock rate is doubled.

1-11. (canceled)

12. A charge pump, comprising:
a control input adapted to apply a control pulse;
a pulsed current source adapted to generate a current pulse in accordance with the control pulse;
a direct current source adapted to generate a direct current; and
a current output connected to an output of the pulsed current source and an output of the direct current source and adapted to superimpose the direct current and the current pulse.

13. The charge pump according to claim 12, wherein the charge pump is arranged as a charge pump for a phase-coupled control loop.

14. The charge pump according to claim 12, wherein the direct current source is adjustable and includes a control input adapted to adjust the direct current.

15. The charge pump according to claim 14, further comprising a direct current control device connected to the control input of direct current source, in order to adjust the direct current in response to a pulse width of the control pulse.

16. The charge pump according to claim 15, wherein the direct current control device includes an analog integrator.

17. The charge pump according to claim 15, wherein the direct current control device includes a digital device adapted to detecting the pulse width.

18. The charge pump according to claim 15, wherein the direct current control device is adapted to modify the direct current when the pulse width of the control pulse increases.

19. The charge pump according to claim 12, wherein the pulsed current source is adapted to output, in response to the control pulse, a current pulse having a width identical to a width of the control pulse.

20. The charge pump according to claim 19, wherein the pulsed current source is adapted to output in response to the control pulse a first current pulse and a second current pulse, each having a width identical to the width of the control pulse, and in response to a reference signal, to output the first current pulse with a rising edge and the second current pulse with a falling edge of a reference signal.

21. The charge pump according to claim 12, wherein the charge pump is arranged as a charge pump of a phase-coupled control loop of an FMCW radar in a motor vehicle.

22. A method for regulating a phase-coupled control loop for an FMCW radar, comprising:
outputting an actual signal via a voltage-controlled oscillator;
providing a reference signal;
at least one of (a) varying the reference signal so that it has a monotonously changing frequency, at least during one time span and (b) dividing a frequency of the actual signal via a monotonously changing divider ratio;
determining a phase difference between the reference signal and the actual signal;
generating a current pulse having a pulse width in response to the determined phase difference;
generating a direct current at least during the time span;
superimposing the direct current with the current pulse to form a current signal; and
injecting the current signal into a control input of a controllable oscillator that generates the actual signal.
